(19) United States
(12) Patent Application Publication
(10) Pub. No.: US 2008/0218996 A1
(43) Pub. Date: Sep. 11, 2008

(54) Hand-Worn Signaling Device

(76) Inventors: Kevin Chalgren Galloway, Aldan, PA (US); Thomas William Mather, Philadelphia, PA (US)

Correspondence Address: Kevin C. Galloway, 133 N. Clifton Ave., Apt A, Aldan, PA, 19018, US

(21) Appl. No.: 12/031,962

(22) Filed: Feb. 15, 2008

Related U.S. Application Data
(60) Provisional application No. 60/905,666, filed on Mar. 8, 2007.

(51) Int. Cl. F21V 21/08; G05F 1/00

(52) U.S. Cl. 362/103; 315/291

(57) ABSTRACT

An improved hand-worn signaling device is disclosed that comprises at least one light-emitting assembly on the palmar side of the hand and at least one light-emitting assembly on the dorsal side of the hand; in one embodiment of the invention, the palmar light-emitting assembly is red and the dorsal light-emitting assembly is green. One embodiment of the device also comprises a controller that detects hand motions by the user and activates the appropriate light-emitting assembly in response. In another embodiment, the controller detects the angle of the user's wrist or knuckles, and activates the appropriate light-emitting assembly depending on the angle of the user's joints. In another embodiment, the controller detects the spatial orientation of the user's hand, and activates the appropriate light-emitting assembly depending on whether the user's hand is positioned vertically with the fingers pointing straight up (the “stop” position) or in any other orientation. An interlock switch that prevents inadvertent activation, and a feedback device that enables the user to tell which light-emitting assembly is on, are also disclosed.

### CROSS-REFERENCE TO RELATED APPLICATIONS

This application claims priority to Provisional Patent Application No. 60/905,666, filed on Mar. 08, 2007.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

(1) Field of the Invention.

This invention relates to warning or signaling devices, particularly to hand-worn warning or signaling devices used for controlling traffic.

(2) Description of Related Art.

Traffic control personnel are frequently assigned to control traffic in situations where traffic lights are unavailable or inoperable. In dark settings, this can be a very dangerous task. Most traffic control personnel use flashlights or beacons to increase their visibility to oncoming traffic; however, while these devices are effective at improving visibility, they are less effective at communicating traffic commands to drivers. Such tools can unnecessarily slow the flow of traffic by increasing driver confusion; moreover, they are heavy and preclude the use of the hand for other purposes.

A variety of hand-worn signaling devices exist in the prior art. They use a variety of light-emitting devices on the glove, and a variety of glove designs; however, the method of controlling the glove is most commonly a pushbutton switch mounted on the index finger, designed to be activated with the thumb. Some designs, however, leave the control method altogether unspecified. The pushbutton control method, while simple, has the disadvantage of requiring conscious action by the user, and of impeding the user's hand function.

One glove-based signaling device was proposed by Mead, in U.S. Pat. No. 6,006,357. The Mead patent discloses a glove with reflective surfaces and/or lights on the front and back of the hand. This device enables the user to direct traffic without holding a heavy flashlight, and improves communication between the user and the driver. While the Mead patent does disclose a light (attached to the glove with a hook-and-loop fastener), it does not disclose a method of turning that light on or off without removing it from the glove. Moreover, the Mead patent only mentions a light attached to the dorsal side of the hand.

Many other patents in this area disclose lights mounted on gloves, because lights are more visible than reflectors. U.S. Pat. No. 3,638,011 to Bain et al. discloses a glove with an attached light controlled by a wrist-mounted mechanical switch. The Bain patent does not allow the user to manually operate the power switch with the glove hand, and has a singular light source mounted on the back of the hand.

Senter et al., in U.S. Pat. No. 7,013,490, discloses an illuminated glove with a light source that can be activated in a continuous light mode or in blinking mode. The Senter patent, however, discloses a glove that only has a single light source (diffused using a flexible lens) on the back of the hand, and none on the palm. The method of controlling the light is by a pushbutton switch located on the index finger of the glove.

A similar device is disclosed in U.S. Pat. No. 6,529,121 by Bush. The device disclosed in the patent is a glove or other hand-wear article that comprises a light- or sound-emitting device on the back of the hand. The device is activated by a pushbutton switch located on the index finger of the glove.

A “hand worn illuminated framework”, patented by Ferrari et al. in U.S. Pat. No. 7,163,308, illuminates both the front and the back of the hand, covering the entire hand in a network of LED lights. However, because this network covers the entire length of each finger, it covers the fingertips and makes most normal uses of the hand impossible. Such a device would not be useful to a traffic control officer, who needs to be able to use his or her hands for many other purposes during the course of a workday.

Similarly, a “nighttime glove”, patented by Gyori, U.S. Pat. No. 6,709,142, discloses a glove with fiber-optic ribbons extending along the fingers of the glove. While this glove is useful for improving night-time visibility during the performance of some sports or other night-time activities, it will not be as useful for a traffic control officer, because, like the glove described in the Ferrari patent, it covers the fingertips. Furthermore, the fiberoptic lights are only visible at the fingertips rather than at the back of the hand. The switch for turning the lights on and off is located on the wrist.

Similarly, a light-emitting glove patented by Mayo, U.S. Pat. No. 6,592,235, discloses a glove with lights located at the fingertips. While this is a useful device for people who need such a glove for illumination, it is not ideal for traffic control officers because the brightest light is directed along the finger rather than outward from the front or back of the hand. The switch controlling the lights is located on the thumb.

A patent application by Abas, Pub. No. US 2007/0076408, discloses a glove with an electroluminescent wire surrounding the perimeter of the glove. While this device is less cumbersome than the Ferrari patent, it still renders many normal uses of the hand impossible because it also covers the fingertips. Furthermore, electroluminescent wire is not as bright as LED lights. The Abas patent does not disclose how such a device should be controlled by the user.

### BRIEF SUMMARY OF THE INVENTION

The present invention comprises an improved traffic safety glove, comprising light-emitting assemblies on both the front and the back of the hand. In one embodiment of the device, the light-emitting assembly on the back of the hand (the dorsal light-emitting assembly) is green and the light-emitting assembly on the palm of the hand (the palmar light-emitting assembly) is red. This enables the user (a traffic safety officer, for example) to communicate with a driver by means of universal gestures (i.e. palm out for “stop”, or a waving hand with the palm facing the user's body for “move along”), and have those gestures clarified by lights whose colors are already familiar to the driver.

One embodiment of the present invention also comprises a controller for the light-emitting assemblies that senses the motion of the user's hand and responds by activating the appropriate light-emitting assembly. For example, in one embodiment of the invention, a “move along” motion will cause the dorsal light-emitting assembly to turn on, and an abrupt stop of the motion (as in a “stop” gesture) will cause the palmar light-emitting assembly to turn on. This will reduce the chance of user error in activating the wrong light or failing to activate the appropriate light, and reduce the cognitive load on the user by making the process automatic.

Another embodiment of the present invention comprises a controller that responds to the hand's spatial orientation and activates the appropriate light-emitting assembly. In a “stop” gesture, the fingers point vertically upward, and in a “move along” gesture, the fingers point in a different direction. The controller will cause the palmar light-emitting assembly to turn on when the fingers point directly upward, and the dorsal light-emitting assembly to turn on when the fingers point in a different direction. In a further embodiment of the invention, the controller can also turn both lights off when the fingers are pointing straight down—i.e. the arm is relaxed.

Another embodiment of the present invention comprises a controller that responds to the angle of the user's joints by means of a flex sensor. In one embodiment, the flex sensor is mounted on the wrist, and the controller causes the palmar light-emitting assembly to turn on when the wrist is flexed in a dorsal direction (as in a “stop” gesture), and the dorsal light-emitting assembly to turn on when the wrist is flexed slightly in a palmar direction (as in a “move along” gesture). In another embodiment, a flex sensor is mounted on one of the metacarpophalangeal joints (knuckle joints) of the hand, and the controller causes the palmar light-emitting assembly to turn on when the joint is straightened (as in a “stop” gesture), and the dorsal light-emitting assembly to turn on when the joint is slightly bent (as in a “move along” gesture). Another embodiment includes both a flex sensor on the wrist joint and a flex sensor on one of the knuckle joints; the controller causes the palmar light-emitting assembly to turn on when the wrist joint is flexed, and the dorsal light-emitting assembly to turn on when the knuckle joint is flexed.

Another embodiment of the present invention comprises a controller that responds to contact between two different areas on the user's hand. In one embodiment, a force sensor can be mounted on the heel of the hand, so that when the user's fingertips touch the sensor, the dorsal light-emitting assembly turns on; when nothing is touching the heel of the user's hand, the palmar light-emitting assembly turns on. In another embodiment, the force sensor is mounted on the tip of the user's thumb, and when the user touches the force sensor, the dorsal light-emitting assembly turns on; when nothing is touching the force sensor, the palmar light-emitting assembly turns on.

While many embodiments of the invention comprise a red light on the palm of the hand and a green light on the back of the hand, another embodiment comprises infrared lights on one or both sides of the hand. This enables the user to communicate in settings where other modes of communication would be impossible, such as military applications where a radio silence and low visibility must be maintained or underwater applications where a visible light would not be advisable. It should be noted that a digital camera, night-vision goggles and the like would be required to see the infrared light signals. Another embodiment of the invention can be used by airline persons to guide airplanes to airport gates; that embodiment comprises visible lights on both the palmar side and the dorsal side of the hand, of colors that are appropriate for that application.

All of the above-described embodiments of the invention can also comprise an interlock switch. One embodiment of the interlock switch is merely an on/off switch that can turn off the lights when the user is not actively directing traffic. Another embodiment of the interlock switch is a pushbutton or moment switch that must be kept pressed in order for the controller to respond to the hand motion, position or flexion. This prevents the user from inadvertently activating the wrong light.

When the user's hand is in proper signaling position, it is often difficult for the user to see whether the correct light-emitting assembly is turned on, as that surface of the hand is likely to be facing away from the user. To alleviate the problem, a feedback device is proposed. One embodiment of the feedback device comprises a light visible to the user when the appropriate light-emitting assembly is turned on. For example, the feedback light for the palmar light-emitting assembly could be located on the dorsal side of the hand, and vice versa. In that embodiment, when the palmar light-emitting assembly is turned on, the feedback light on the dorsal side of the user's hand is turned on; that feedback light is visible to the user. Similarly, when the dorsal light-emitting assembly is turned on, the feedback light on the palmar side of the user's hand is turned on and visible to the user. Another embodiment of the feedback device is a light that is located on the side of the user's hand in such a way that it is visible to the user regardless of the hand position. A further embodiment of the feedback device comprises a vibrating module that vibrates when a light-emitting assembly is turned on. This has the advantage of not requiring the user to look at the device, and can be programmed to vibrate in several different patterns to enable the user to detect which light-emitting assembly is on.

### BRIEF DESCRIPTION OF THE SEVERAL VIEWS OF THE DRAWINGS

FIG. 1 shows a traffic control officer illustrating a “stop” gesture with the right hand and a “move along” gesture with the left hand.

FIG. 2(a) shows a dorsal view of one embodiment of the invention, comprising a fingerless glove, a wrist-mounted controller, and a light-emitting assembly mounted on the dorsal side of the hand.

FIG. 2(b) shows a palmar view of the same embodiment of the invention, comprising a light-emitting assembly mounted on the palmar side of the hand.

FIG. 2(c) shows one possible location for the interlock switch.

FIG. 3(a) shows a block diagram of the controller for the embodiment of the invention that comprises an accelerometer.

FIG. 3(b) shows a block diagram of the controller for the embodiment of the invention that comprises a flex sensor.

FIG. 3(c) shows a block diagram of the controller for the embodiment of the invention that comprises a force sensor.

FIG. 4(a) shows a diagram of an accelerometer-based controller registering the direction of the gravitational force when the user makes a “stop” gesture.

FIG. 4(b) shows a diagram of an accelerometer-based controller registering the direction of the gravitational force when the user makes a “move along” gesture.

FIG. 5(a) shows a palmar view of one embodiment of the invention, comprising a flex sensor located at the wrist.

FIG. 5(b) shows a dorsal view of one embodiment of the invention, comprising a flex sensor located at one of the metacarpophalangeal joints.

FIG. 6(a) shows a palmar view of one embodiment of the invention, comprising a force sensor located at the heel of the hand.

FIG. 6(b) shows a palmar view of another embodiment of the invention, comprising a force sensor located at the tip of the thumb.

FIG. 7(a) shows one embodiment of the feedback device, comprising a light that illuminates when the light-emitting assembly on the other side of the hand is illuminated.

FIG. 7(b) shows another embodiment of the feedback device, comprising a light that is visible from both sides of the hand.

FIG. 7(c) shows another embodiment of the feedback device, comprising a vibrating module.

### DETAILED DESCRIPTION OF THE INVENTION

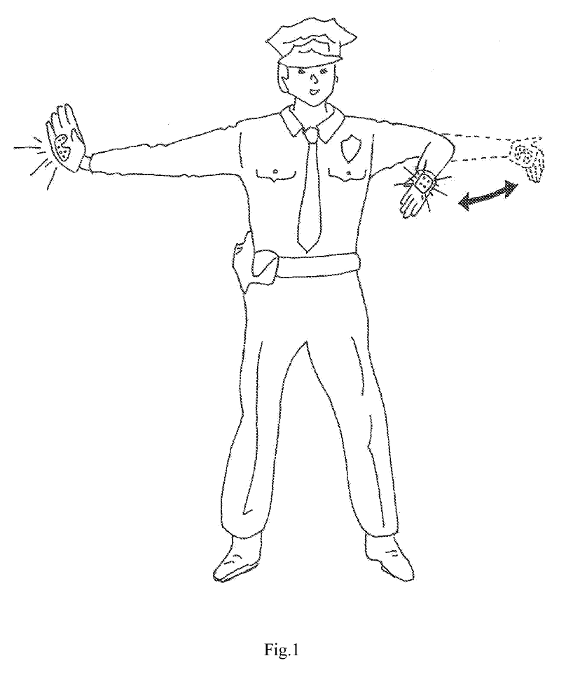

As illustrated in FIG. 1, when a traffic control officer makes a “stop” gesture, the palm of his or her hand is facing the person in front of him or her; when the officer makes a “move along” gesture, the back of his or her hand is facing the person in front of him or her. The present invention is a wearable device that will improve driver comprehension of these gestures by illuminating the hand surface visible to the driver with a red light when the officer makes a “stop” gesture and with a green light when the officer makes a “move along” gesture. Such an invention can also be used for guiding airplanes to the appropriate airport gate, military applications, or any other applications requiring communication with hand signals in dark environments.

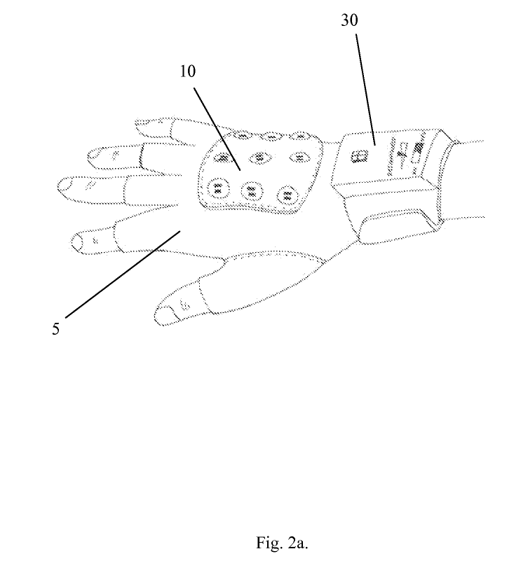

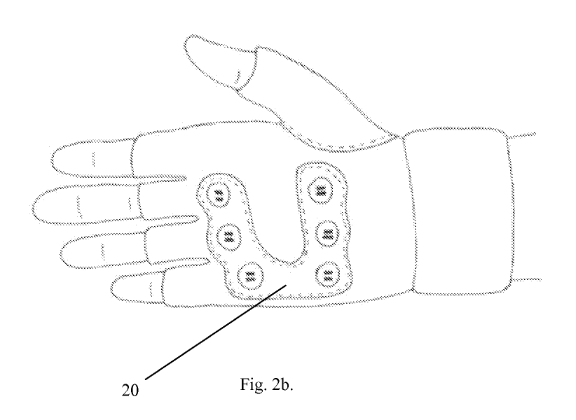

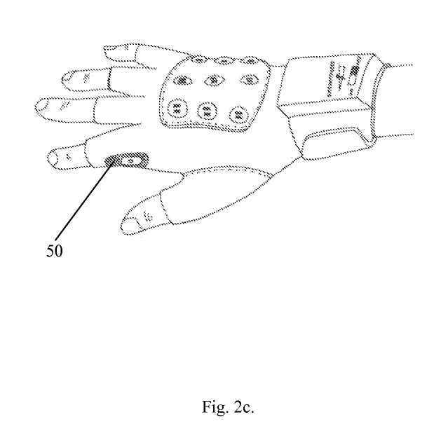

FIGS. 2(a) and 2(b) show the basic construction of one embodiment of the invention. The light-emitting assembly 10 (the “dorsal light-emitting assembly”) is located on the dorsal side of the hand and emits a green light when activated. The light-emitting assembly 20 (the “palmar light-emitting assembly”) is located on the palm of the hand and emits a red light when activated. Both light-emitting assemblies are electrically connected to controller 30. As is shown in FIG. 2(c), an alternate embodiment of the invention also comprises an interlock switch 50 to prevent the light-emitting assemblies from being activated when the user is not actively directing traffic. The light-emitting assemblies 10 and 20 can be made detachable from the glove body 5 for easy cleaning or repair. The glove body 5 can be fingerless (as illustrated in FIG. 2(a)) or it can cover the hand in its entirety.

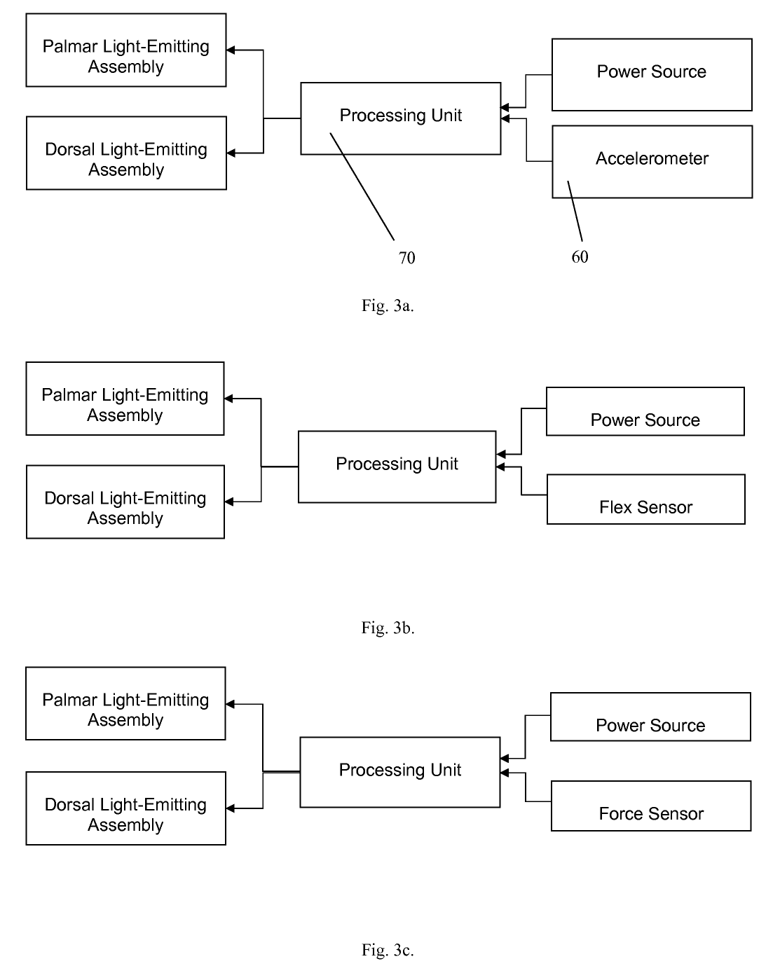

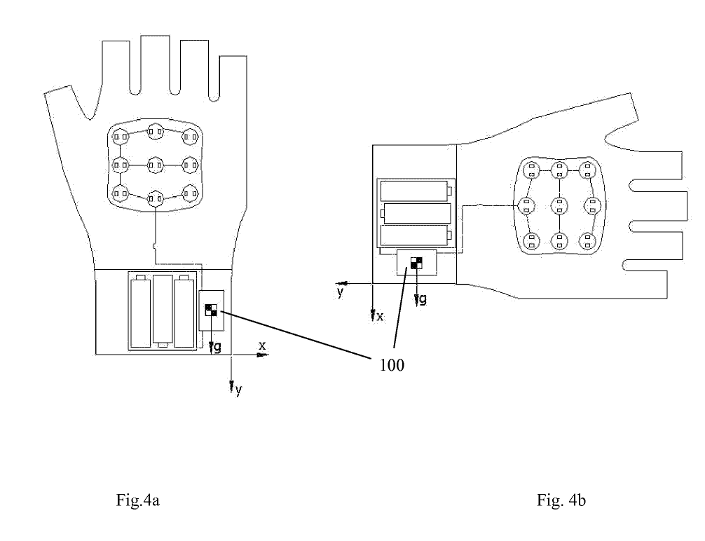

FIGS. 3(a), 3(b), and 3(c) show block diagrams of three different embodiments of the controller. In FIG. 3(a), the accelerometer 60 sends data to processing unit 70. The processing unit compares the data received from the accelerometer with its library of predefined motion patterns. If the received data is consistent with a “move along” motion pattern, the processing unit causes the dorsal light-emitting assembly to illuminate and the palmar light-emitting assembly to turn off, if the received data is consistent with a “stop” motion pattern, the processing unit causes the palmar light-emitting assembly to illuminate and the dorsal light-emitting assembly to turn off.

In another embodiment of the invention, illustrated in FIG. 4, the accelerometer 100 is used to measure the spatial orientation of the hand rather than its motion. In that embodiment, the processing unit compares the data received from the accelerometer with its library of predefined direction patterns. If the hand is vertical, as in FIG. 4(a), the accelerometer 100 will detect a gravitational force pointing downward, parallel to the fingers. If the hand is horizontal, as in FIG. 4(b), the accelerometer 100 will detect a gravitational force pointing in a different direction with respect to the fingers. The processing unit 70 will then cause the the palmar light-emitting assembly to illuminate when the accelerometer detects a gravitational force pointing parallel to the fingers, and the dorsal light-emitting assembly to illuminate when the accelerometer detects a gravitational force pointing in any other direction. If the user's hand is hanging downward, relaxed, the processing unit 70 will cause both light-emitting assemblies to turn off.

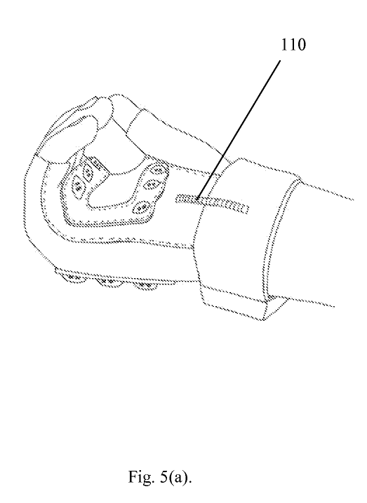

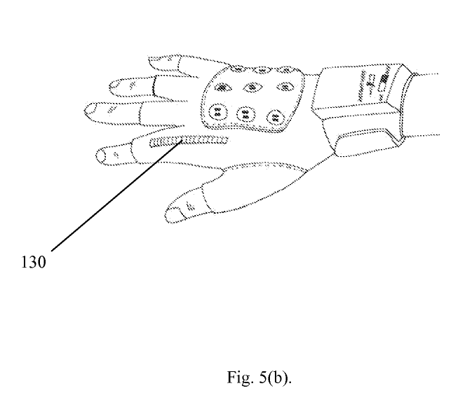

Another embodiment of the present invention is illustrated in FIG. 5(a), which uses a flex sensor 110 to detect the angle of the wrist. FIG. 3(b) shows a block diagram of the controller for that embodiment of the invention. When the hand is held in front of the body in a “stop” position, the wrist is bent at a near-90-degree angle; when the hand is moved in a “move-along” motion, the wrist is nearly straight. The flex sensor 110 determines the angle of the wrist joint and sends that data to the processing unit, which turns on the dorsal light-emitting assembly when the flex sensor reports an angle that is greater than a pre-set limit, and turns on the palmar light-emitting assembly when the flex sensor reports an angle that is smaller than the pre-set limit. FIG. 5(b) illustrates another embodiment of the invention; in that embodiment, the flex sensor 130 is located on one of the metacarpophalangeal joints. When the user makes a “stop” gesture, the metacarpophalangeal joints are straightened; when the user makes a “move along” gesture, the metacarpophalangeal joints are slightly bent. The controller will therefore turn on the palmar light-emitting assembly when the flex sensor 130 reports an angle that is larger than some pre-set limit, and turn on the dorsal light-emitting assembly when the flex sensor 130 reports an angle that is smaller than the pre-set limit. A further embodiment of the invention comprises two flex sensors: one flex sensor at the wrist joint and one flex sensor at a metacarpophalangeal joint. In this embodiment, the controller will turn on the palmar light-emitting assembly when the flex sensor at the wrist joint reports an angle that is smaller than some pre-set limit, and turn on the dorsal light-emitting assembly when the flex sensor at the metacarpophalangeal joint reports an angle that is smaller than some pre-set limit.

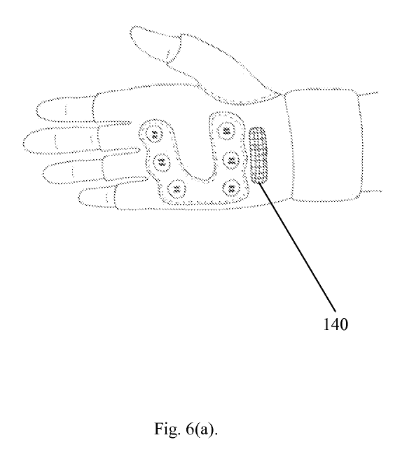

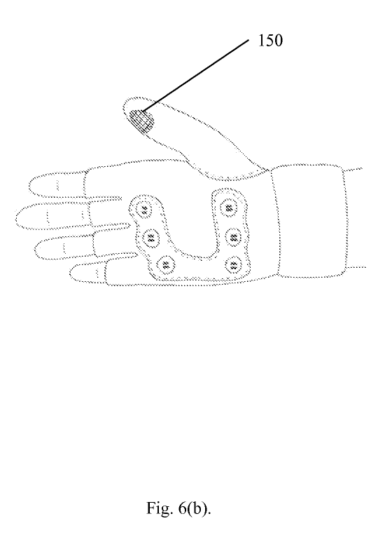

Another embodiment of the invention, illustrated in FIG. 6(a), uses a force sensor 140 to control the light-emitting assemblies. To activate the dorsal light-emitting assembly, the user would need to touch the force sensor 140 with the fingertips. The controller could be programmed to turn on the dorsal light-emitting assembly whenever the force sensor 140 is touched, and to turn on the palmar light-emitting assembly at all other times. As shown in FIG. 6(b), the force sensor 150 could also be located on the thumb. In this embodiment of the invention, the controller could be programmed to turn on one of the light-emitting assemblies when force is applied to the user's thumb, and to turn on the other one when no force is applied.

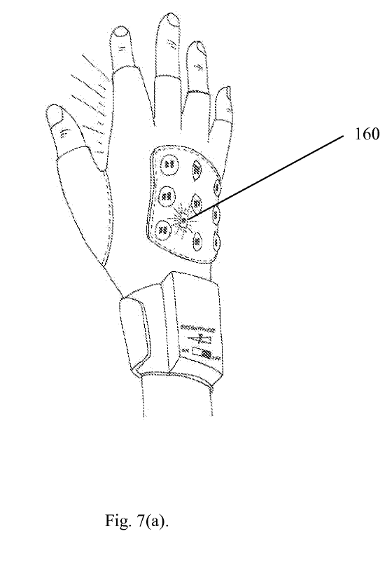

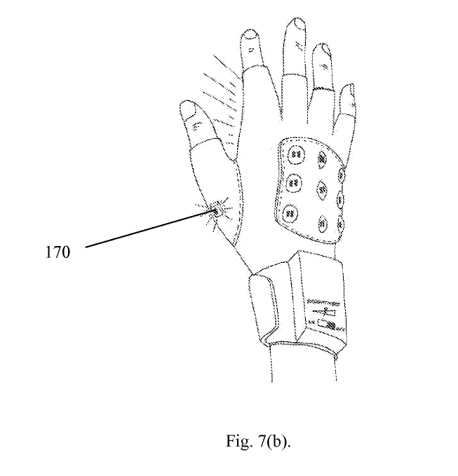

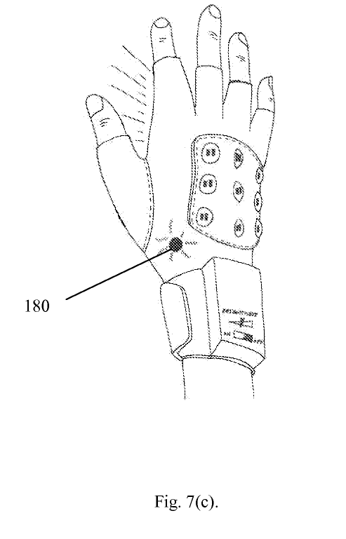

One of the problems with a glove-based traffic control device is that the user cannot always see whether the light is on while the device is in use. When the user is making a “stop” gesture, the palm of the hand is facing away from the body; it is not always possible to see whether the palmar light-emitting assembly is on from that position. Similarly, when the user is making a “move-along” gesture, the back of the hand is facing away from the user, making the dorsal light-emitting assembly hard to see. A feedback device is proposed that will enable the user to easily verify that the correct light-emitting assembly is on. One embodiment of the feedback device is illustrated in FIG. 7(a). In this embodiment, each light-emitting assembly comprises at least one light that illuminates when the other light-emitting assembly is on. FIG. 7(a) shows light 160, which is illuminated when the palmar light-emitting assembly is illuminated. Similarly, the palmar light-emitting assembly can comprise at least one light that illuminates when the dorsal light-emitting assembly is on. The advantage of this embodiment is that it does not require an additional light-emitting assembly; all it requires is an extra light to add to the existing light-emitting assemblies.

Another embodiment of the feedback device is illustrated in FIG. 7(b). In that embodiment, light 170 is located in such a location that it can be visible regardless of the orientation of the hand. It can be either a bi-color light that illuminates with the same color as the light-emitting assembly, or a mono-color light that illuminates when any light-emitting assembly is on. The advantage of this embodiment is that it requires only one light; however, it may be harder for the user to see.

Another embodiment of the feedback device, illustrated in FIG. 7(c), uses vibration instead of light to provide feedback to the user. In that embodiment, vibrating module 180 vibrates when one of the light-emitting assemblies is turned on. It can be set to vibrate in a pulse mode when one light-emitting assembly is turned on and in a steady mode when the other one is turned on, to give the user an easy way to distinguish between them. Though the illustration shows it located on the back of the hand, the vibrating module can be located anywhere on the hand that does not interfere with normal hand use.

1. A hand-worn signaling device, comprising:
a glove body adapted to be worn on a user's hand;
at least one light-emitting assembly attached to the glove body;
a controller for selectively activating said light-emitting assembly.

2. A hand-worn signaling device as in claim 1, wherein one light-emitting assembly is attached to the palmar side of the hand and one light-emitting assembly is attached to the dorsal side of the hand.

3. A hand-worn signaling device as in claim 1, wherein at least one light-emitting assembly emits infrared light.

4. A hand-worn signaling device as in claim 2, wherein the dorsal light-emitting assembly emits a green light, and the palmar light-emitting assembly emits a red light.

5. A hand-worn signaling device as in claim 1, further comprising an interlock switch that disables all the light-emitting assemblies.

6. A hand-worn signaling device as in claim 1, further comprising an interlock switch that must be operated in conjunction with the controller in order to change the state of the light-emitting assemblies.

7. A hand-worn signaling device as in claim 2, wherein the controller comprises a means for detecting the spatial orientation of the user's hand.

8. A hand-worn signaling device as in claim 7, wherein the palmar light-emitting assembly is turned on and the dorsal light-emitting assembly is turned off when the user's hand is placed in a vertical position with the fingers pointing upward, and the palmar light-emitting assembly is turned off and the dorsal light-emitting assembly is turned on when the user's hand is placed in any other position.

9. A hand-worn signaling device as in claim 2, wherein the controller comprises a means for detecting hand motions by the user.

10. A hand-worn signaling device as in claim 9, wherein the dorsal light-emitting assembly is turned on and the palmar light-emitting assembly is turned off when motion is detected, and the palmar light-emitting assembly is turned on and the dorsal light-emitting assembly is turned off when no motion is detected.

11. A hand-worn signaling device as in claim 2, wherein the controller comprises a means for detecting the angle of the user's joints.

12. A hand-worn signaling device as in claim 11, wherein the palmar light-emitting assembly is turned on and the dorsal light-emitting assembly is turned off when the wrist is flexed towards the dorsal side, and the palmar light-emitting assembly is turned off and the dorsal light emitting assembly is turned on when the wrist is flexed towards the palmar side.

13. A hand-worn signaling device as in claim 11, wherein the palmar light-emitting assembly is turned on and the dorsal light-emitting assembly is turned off when the user's metacarpophalangeal joints are extended, and the palmar light-emitting assembly is turned off and the dorsal light emitting assembly is turned on when the user's metacarpophalangeal joints are flexed.

14. A hand-worn signaling device as in claim 11, wherein the palmar light-emitting assembly is turned on and the dorsal light-emitting assembly is turned off when the user's wrist joint is flexed towards the dorsal side, the palmar light-emitting assembly is turned off and the dorsal light emitting assembly is turned on when the user's metacarpophalangeal joints are flexed, and both light-emitting assemblies are turned off when the user's wrist joint and metacarpophalangeal joints are all extended.

15. A hand-worn signaling device as in claim 2, wherein the controller comprises a means for detecting physical contact between one part of the hand and another part of the hand.

16. A hand-worn signaling device as in claim 15, wherein the dorsal light-emitting assembly is turned on and the palmar light-emitting assembly is turned off when the user's fingertips touch the heel of the user's hand, and the palmar light-emitting assembly is turned on and the dorsal light-emitting assembly is turned off when the user's fingertips do not touch the heel of the user's hand.

17. A hand-worn signaling device as in claim 15, wherein the dorsal light-emitting assembly is turned on and the palmar light-emitting assembly is turned off when force is applied to the user's thumb, and the palmar light-emitting assembly is turned off and the dorsal light-emitting assembly is turned on when no force is applied to the user's thumb.

18. A hand-worn signaling device as in claim 2, further comprising a feedback device for conveying information to the user about the state of the light-emitting assemblies.

19. A hand-worn signaling device as in claim 18, wherein the feedback device comprises a light visible to the user when the hand is in a signaling position.

20. A hand-worn signaling device as in claim 18, wherein the feedback device comprises a module that provides tactile feedback to the user.

21. A controller for a hand-worn signaling device, comprising a module that changes the state of the signaling device in response to user input.

22. A controller for a hand-worn signaling device as in claim 21, further comprising an interlock switch that disables the light-emitting assemblies.

23. A controller for a hand-worn signaling device as in claim 21, further comprising an interlock switch that needs to be activated in order for the controller to change the state of the signaling device in response to user input.

24. A controller for a hand-worn signaling device as in claim 21, where the user input is a hand motion.

25. A controller for a hand-worn signaling device as in claim 21, where the user input is a change in hand spatial orientation.

26. A controller for a hand-worn signaling device as in claim 21, where the user input is a change in the angle of a hand joint of the user.

27. A controller for a hand-worn signaling device as in claim 21, where the user input is physical force applied to a location on the user's hand.
